(19) United States
(12) Patent Application Publication
(10) Pub. No.: US 2007/0016458 A1
(43) Pub. Date: Jan. 18, 2007

(54) Accounting for individuals before or during a crisis

(75) Inventors: J. Michael Angle, Norcross, GA (US); Karen Fulford, Alabaster, AL (US); Doug Langley, Atlanta, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/214,373

(22) Filed: Aug. 29, 2005

Related U.S. Application Data
(60) Provisional application No. 60/691,923, filed on Jun. 17, 2005.

(51) Int. Cl. G06F 9/44

(52) U.S. Cl. 705/7

(57) ABSTRACT

Embodiments provide methods and a system used to account for individuals during or before a crisis situation. The methods and system provide a program configured to account for one or more missing individuals if an entity is affected by a crisis. The program is configured to pose a number of questions to one or more individuals who have accessed the program. The program records information associated with the posed questions. A log of the information is generated. Thereafter, the log of information is merged with other associated data to obtain an accountability report. The accountability report can be used to account for missing individuals.

### BACKGROUND

Unfortunately, we live in a dangerous world. Humankind seems to be under constant threat. Mother nature provides her share of threats: hurricanes, tornados, earthquakes, tsunamis and other natural disasters. Regional conflicts and war also continue to threaten the well being of society. Furthermore, with the recent rise of terrorist attacks and threats, humankind must now be extra vigilant in protecting various assets and loved ones. The terrorist attacks that took place on September 11, 2001, taught an invaluable lesson to the citizens of the United States and around the globe. The devastation of the twin towers and resulting chaos, while terrible, provided an impetus to the American public to not be caught off guard again. In the midst of the chaos and afterward, businesses and families desperately attempted to locate personnel and loved ones. Pictures and other identification criteria were publicly posted in attempts to locate the missing. Regrettably, in many instances, the missing were never found.

### SUMMARY OF THE INVENTION

Embodiments of the present invention address the above and other problems by providing mechanisms to locate individuals and other assets during or before a crisis situation. Embodiments include methods and systems which provide a program configured to account for one or more missing individuals if an entity is affected by a crisis. The program is configured to pose a number of questions to one or more individuals who have accessed the program. The program records information associated with the posed questions. A log of the information is generated. Thereafter, the log of information is merged with other associated data to obtain an accountability report. The accountability report can be used to account for missing individuals.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary operating environment;

FIG. 2 is a flow diagram depicting an employee accounting process according to an embodiment;

FIG. 3A-3B depict a report which can be utilized in accounting for missing employees according to an embodiment; and

FIG. 4 is a functional block diagram depicting resources utilized in the compilation and use of an accountability report according to an embodiment.

### DETAILED DESCRIPTION

As briefly described above, embodiments of the invention are directed to methods and systems used in accounting for one or more individuals. The methods and systems can be implemented during or before a crisis situation. The embodiments enable designated personnel of an entity or others to account for missing individuals in an efficient and expedited manner, as described in detail below.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

Exemplary Operating Environment

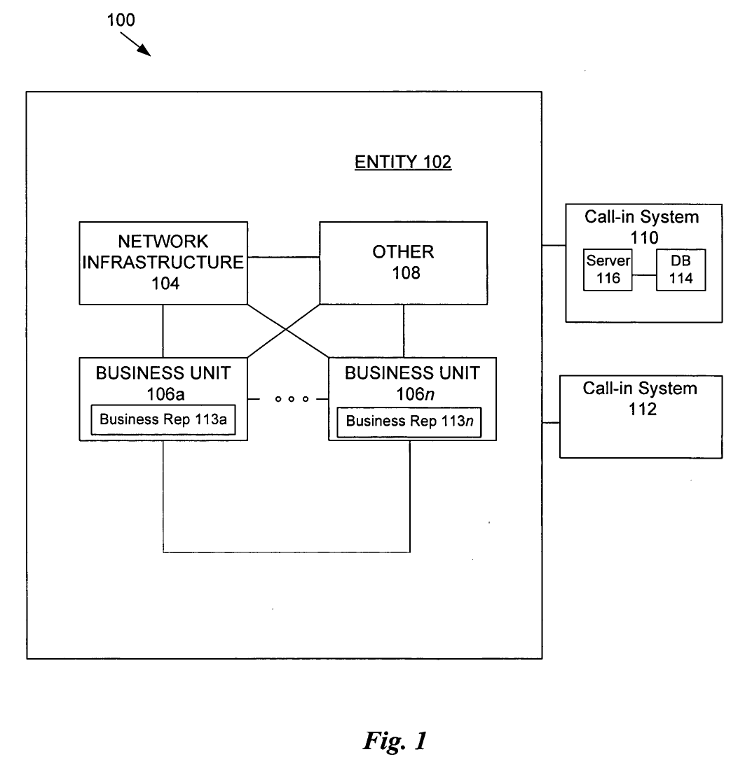

Referring now to the drawings, in which like numerals represent like elements through the several figures, aspects of the present invention and the exemplary operating environment will be described. FIG. 1 and the following discussion are intended to provide a brief, general description of a suitable operational environment in which the invention may be implemented.

FIG. 1 depicts an exemplary operating environment 100 for implementing embodiments of the invention. The exemplary operating environment 100 of FIG. 1 is shown to include an entity 102, such as a headquarters, central office, central control, and the like, or other establishment. However, the exemplary operating environment 100 is not limited to a single entity 102, and may include multiple such entities in various configurations, separated or co-located. The entities may be located across a certain distance (country to country, city to country, county to county, city to city, block to block, etc.).

The entity 102 includes a network infrastructure 104 (LAN, WAN, and other types) which provides communication capabilities between a number of business units 106a-106n (where n is an integer) and other entities 108. The network infrastructure 104 can include wireline, wireless, and/or a combination of both communication capabilities. Preferably, the network infrastructure 104 includes communication links or capability between the various business units 106a-106n and other entities 108 allowing for communication therebetween. The entity 102 is also in communication with one or more call-in systems 110 and 112 (discussed below). One exemplary call-in system 110 is offered by AT&T as “AT&T Business Direct”. The web address associated with the service is “www.businessdirect.att.com”. As described below, the tool can be automated to elicit and collect information. Thereafter, a web or other interface can be used to interact with the tool to view, to organize, and/or to collect information, etc.

Even though the entity 102 is shown as a unitary block, it will be appreciated that various features of the entity 102 can be located at different locations and is not intended to be necessarily restricted to any specific site. In one embodiment, certain business units 106a-106n are located at different locations, while others can be located at the same site or building, or within a distance from one another. That is, entity 102 may have both remote and local business units 106a-106n and/or a combination of both. It will be appreciated, however, that while certain embodiments are described herein, the invention is not intended to be limited by any specific examples or embodiments.

In a preferred embodiment, the entity 102 comprises a business which includes various resources and departments, such as a Human Resources department, Marketing department, Public Relations department, Security department, etc., network/communication infrastructure and equipment (e-mail servers, phones, data repositories, servers, etc.), and a number of employees. The business is divided into a number of business units 106a-106n, wherein each business unit can be associated with various resources, responsibilities, and/or departments. As described above, the business units 106a-106n may be co-located or separated across a distance. The business units 106a-106n are typically organized based on a particular function or service. Each business unit 106a-106n preferably includes at least one business continuity representative or manager 113a-113n.

“Business continuity” can be described as a function of a person or persons responsible for ensuring that a business' critical operations continue during and after an emergency or other incident of concern. Preferably, at least one business continuity representative 113a-113n is associated with a particular business unit 106a-106n. Each business continuity representative 113a-113n is tasked with the responsibility for ensuring that critical operations associated with its business unit 106a-106n continue without prolonged periods of downtime or inefficiency. Each business continuity representative 113a-113n is also tasked with the responsibility of knowing its employee whereabouts during normal business hours and/or at other prescribed times. The business can also include a business continuity crisis team which collects and disseminates information to the business continuity representatives 113a-113n during crisis and other situations.

Typically, the Human Resources department retains the employee contact information and operates as a conduit to provide the contact information to the business continuity representatives 113a-113n and other select individuals or entities. The contact information may also be made available in a separate database or store which can be accessed after entering proper identification information (such as a username and password, for example). The Public Relations department is typically charged with maintaining the image of the business through internal and external communications. The Public Relations department has access to multiple channels of communication to deliver information to the employees and to the external media if required. Human Resources also preferably maintain and support the call-in systems 110 and 112.

The call-in system 110 is preferably an automated system that responds to incoming phone calls (or other inputs) with a structured set of questions and responses which are based on the answers to the questions. The answers can be input to the call-in system 110 using an communication device, such as a telephone, personal data assistant, web interface, microphone, messaging system, etc. The call-in system 110 records the caller's responses based on the associated questions. The automated call-in system 110 can be tailored to ask specific questions and maintain an inventory of information, such as: persons who have called, the number called from, the time, and other information provided during the call (usually through tactile or voice input).

A web or other interface can be used to access a list of all people and the related information (stored on a central server) who have called in during a certain timeframe. The call-in system 110 can date and time-stamp the call, record the incoming number, and ask a series of questions, such as: the State where the person is calling from; identification information (such as a social security number or password), and any other associated information. The call-in system 110 stores a record of the call and the information in a central database 114 on a server 116. A user can then query the database 114 for certain periods using a web or other interface. If not “okay”, the call-in system 110 can direct the person to take certain follow-up actions, such as information related to call-in system 112. The call-in system 110 can also forward the information to another individual for follow-up actions, such as contacting significant others, and other pertinent contacts or associations. It should be appreciated that the call-in system 110 can be automated to push the data to one or more different repositories (server(s) and/or database(s)). For example, the data and/or reports can be e-mailed or otherwise communicated to certain individuals.

As an example, the call-in system 110 can be tailored to ask a series of questions like: “Are you a company employee?”; What state do you work in (enter “1” for AL, “2” for GA, etc.)”; “enter the last 7 digits of your social security number”, etc. As described above, the call-in system 110 can maintain an inventory of who has called in, the time/date of the call, the incoming phone number, etc.

The information is then stored in a central database 114. It will be appreciated that the information may be stored in multiple locations and/or accessible from multiple locations. Thereafter, select individuals, Human Resource employees for example, can use an automated tool, such as a web interface or other interface to download a listing of employees. The individual or individuals can use various criteria to determine what information to download from the call-in system 110, such as which employees have called the call-in system 110 during a particular time frame. The information then can be merged with an internal business database to generate a report, described further below.

The call-in system 112 can also be tailored to provide certain information to individuals who utilize the service. Preferably, the call-in system 112 is updated on a frequent basis to provide information to employees and other individuals associated with the business. The call-in system 112 can include a prerecorded message about steps to take in case of an incident or other circumstance. If the business decides to activate the call-in system 110, the call-in system 112 will preferably include a message alerting employees to the fact that the call-in system 110 is activated and any required steps to take, such as calling in if they are “okay”.

Employees and other individuals can call the call-in system 112 any time, any day to find out if anything is going on with the business. For example, if a hurricane strike is imminent, the call-in system 112 would include information about the hurricane's intended path and the business operating strategy should the hurricane strike near business assets. As further example, if Atlanta was under a terrorist alert, the call-in system 112 could include a message informing all Atlanta employees to call the call-in system 110. When activated, the call-in systems 110 and 112 provide an additional mechanism for determining if individuals associated with the business are okay or if further action may be required. Alternatively, a web interface and related computing devices can provide the functionality of the call-in systems 110 and 112. That is, a user can check a website to obtain and provide information, such as the information described above. Also, an e-mail system can be employed which provides the foregoing functionality.

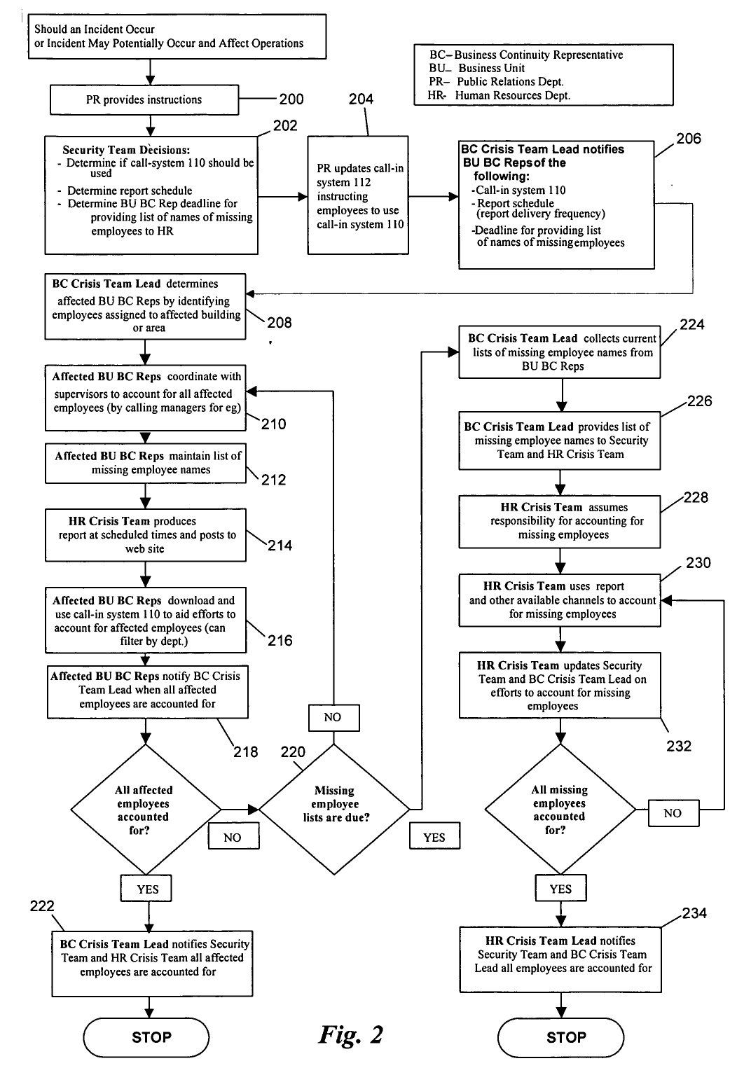

Referring now to the flow diagram of FIG. 2, an embodiment illustrates a process configured to account for individuals or personnel, such as employees, associated with an entity, such as a business, during a crisis situation. For this embodiment, it is assumed that an incident has occurred or is projected to occur within an amount of time. The Public Relations department preferably assumes responsibility for communicating with business continuity representatives 113a-113n and/or employees of particular business units 106a-106n that may be affected by the incident. At 200, using multiple channels of communication (e-mail, pagers, mobile devices, etc.), the Public Relations department instructs potentially affected employees to contact their business continuity representatives 113a-113n and the business continuity representatives 113a-113n to contact its associated employees.

To help expedite the process, it is preferred to quickly determine impacted or potentially impacted business units 106a-106n. The process preferably determines particular business units 106a-106n that are or may be impacted, so that resources are not unnecessarily provisioned to unaffected business units 106a-106n. For example, the crisis may only affect one building being used by a single business unit. A more efficient process can be realized by focusing on the affected units, rather than getting unaffected business unit representatives together, since only one business unit area is affected.

At 202, the security team, based on the current situation, determines if the call-in system 110 should be activated. It will be appreciated that the security team can be a separate department or composed of one or more individuals representing one or more departments, units, and/or functions. Preferably, the security team is an interdepartmental team responsible for coordinating the business' response to a crisis which has the potential to impact the business and its employees. The security teams also specify a report schedule. The report schedule is a designated time for generating and disseminating a report to designated personnel regarding the crisis or potential crisis. The report can consist of information associated with the call-in system 110 and other internal information, described further below.

Additionally, the security team specifies a deadline to affected business continuity representatives 113a-113n to provide a list of employees who are missing (unable to contact) to the Human Resources department. At 204, if the security team has decided to use the call-in system 110, the Public Relations department updates the call-in system 112 to instruct employees to use the call-in system 110. At 206, the business continuity crisis team notifies business continuity representatives 113a-113n of affected or potentially affected business units 106-106n that the call-in system 112 has been activated. The business continuity crisis team also notifies the business continuity representatives 113a-113n of the report schedule and a deadline for providing a list of the missing employees that they are responsible for. The list preferably would not include successful calls to and calls from the associated employees.

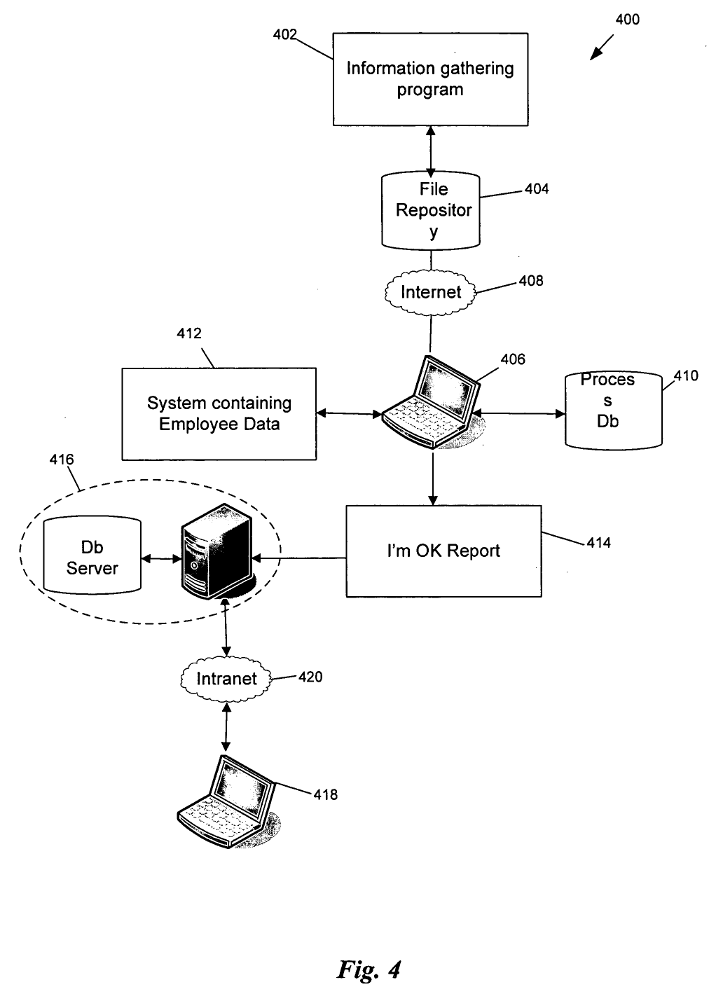

At 208, based on the crisis or potential crisis, the business continuity crisis team lead determines affected business continuity representatives 113a-113n by identifying employees that are assigned to potentially affected buildings or locations. At 210, the business continuity representatives 113a-113n coordinate with their supervisors and others to account for all affected employees (by calling, paging, e-mailing, etc.). At 212, the affected business continuity representatives 113a-113n maintain a list of employees who are missing (i.e. no contact has been made). The list is preferably stored in a central database, so that all lists can be easily combined (see FIG. 4).

Preferably, the Human Resources department includes one or more crisis team representatives who are charged with downloading information (based on queries) from the call-in system 110 after a crisis situation occurs or at some other desired time. The information is preferably extracted from the database 114 after the occurrence of an incident. The information can also be automatically communicated to a crisis team representative, via e-mail, or other communication channels, such as instant messaging, and other wireless communication. At 214, a crisis team representative extracts information from the database 114, since the call-in system 110 has been activated and the designated time period has elapsed (described at 206). Preferably, the crisis team representative uses a web interface to log into the call-in system 112. The crisis team representative can use the interface to enter a timeframe (i.e., Start date and time through end date and time) to obtain the targeted call-in data. The interface then provides all data associated with calls placed to the call-in system 110 during the timeframe. The data is saved to a central server.

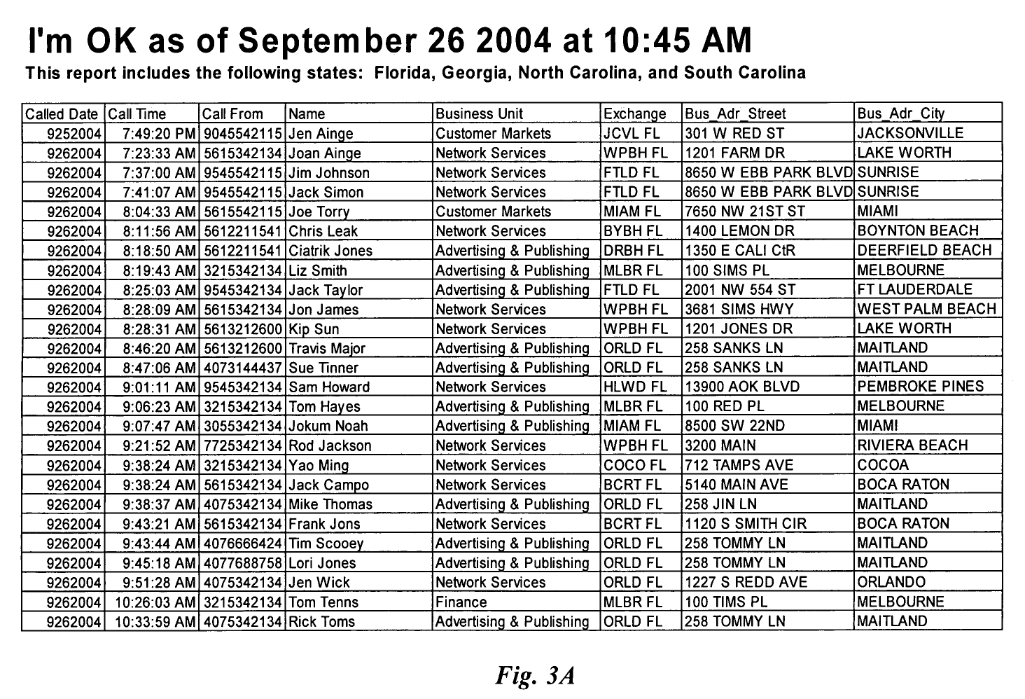

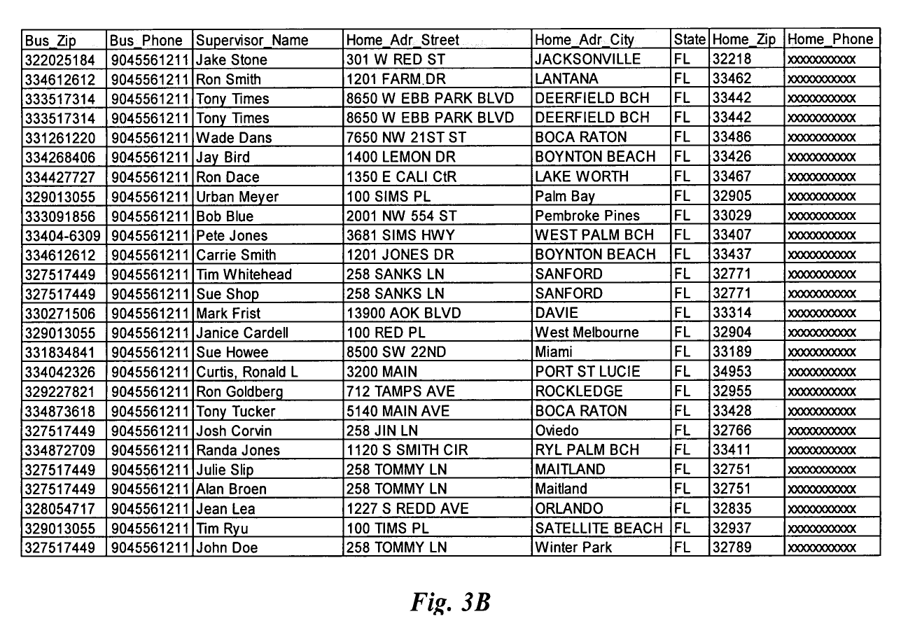

The extracted data is then merged with an employee source database based on the last 7 digits of the employee Social Security number (through queries), which was entered by the employee when they called the call-in system 110 during the prescribed period. The employee source database includes information related to the employee, including business related information. FIGS. 3A-3B depict a sample of the merged information which can be utilized to account for missing employees. As shown in FIGS. 3A and 3B, a variety of information can be included in the merged data output. The information can include, but is not limited to: the called data and time; the number called from; name of the caller; associated business unit; exchange; business address information; supervisor name; and the caller's home contact information.

Continuing at 214, the merged data is then exported to an accountability file (a spreadsheet for example). The accountability file can then be filtered (by business unit, for example) and posted to a predetermined web site. At 216, the affected business continuity representative(s), using a web interface, may then access the web site and download the file/report.

Using the downloaded file, the affected business continuity representatives now have additional data regarding their potentially affected employees. So, for example, if the phone infrastructure is inoperable so they cannot make calls, the business continuity representatives, at a minimum, can review the downloaded accountability file to determine the status of employees. If they have an employee in Florida that they can't find because the phones were out, they can look at the file and say “There's Sam, I wonder if he was okay and now I show that he's on this report from the call-in system 110.” At 218, affected business continuity representatives notify the crisis team lead or leaders when all affected employees have been accounted for. At 222, the business continuity crisis team lead notifies the security team and the human resources crisis team that all affected employees have been accounted for.

If all affected employees have not been accounted for, at 220, the deadline for reporting missing employees is checked. If the deadline has not passed (see 202), the flow cycles back to 210. If the deadline has passed, at 224 the business continuity crisis team lead collects the most current lists of missing employees from the business continuity representatives. At 226, business continuity crisis team lead provides a list of missing employees to the security team and the human resources crisis team. At 228, the human resources crisis team assumes responsibility for accounting for the missing employees. At 230, human resources crisis team uses the accountability report and other available channels in attempts to locate missing employees. At 232, the human resources crisis team updates the security team and the business continuity crisis team lead regarding the status of accounting for the missing employees. If all missing employees have been accounted for, at 234, the human resources crisis team lead notifies the security team and the business continuity crisis team lead. Otherwise, the flow cycles back to 230 and the human resources crisis team continues to account for the missing employees.

Referring now to FIG. 4, a functional block diagram depicts a system 400 including resources utilized in the compilation and use of an accountability report according to an embodiment. The system 400 can be utilized before or after a crisis situation. The system includes an information-gathering program 402. Individuals associated with an entity can interact with and provide information to the information-gathering program 402 (such as call-in system 110). The program 402 is configured to collect information based on the interaction. The system also includes a file repository 404 for saving the collected information.

The system 400 also includes a computing device 406 which, for this embodiment, communicates with the file repository 404 through the internet 408. It will be appreciated that the computing device 406 can be a personal computer, server, mobile, or other computing device, and can communicate using other communication methods. The computing device 406 can save the collected information accessed from the file repository 404 to a database 410. The computing device 406 is configured to merge the collected information stored in database 410 with additional data 412 (as described above) to generate an accountability report 414. The merge process may be based on queries using a spreadsheet application, for example. The accountability report 414 can then be stored on a database server 416. Thereafter, select individuals can use a computing device 418 to access the accountability report 414 over an intranet 420 (or internet) communication channel. The accountability report 414 can also be automatically communicated to one or more select individuals, such as via e-mail, or other communication channels (wireless, etc.). The accountability report 414 can be utilized in various ways to account for individuals associated with an entity.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices. The term computer readable media as used herein includes both storage media and communication media.

It should be appreciated that various embodiments can be implemented as a sequence of acts and implemented using software and hardware resources. In one embodiment, one or more software applications are used to record and disseminate the information described above. That is, the procedure described above can be automated and executed from one or more computer systems to provide the various acts and procedures described above. Accordingly, logical operations may be implemented in software, firmware, special purpose digital logic, and any combination thereof. Moreover, the logical operations described herein can be rearranged to flow in many other implementations and combinations.

Although various exemplary embodiments have been described, those of ordinary skill in the art will understand that many modifications can be made thereto. Accordingly, it is not intended that the scope of the invention in any way be limited by the above description and other embodiments of the invention will be apparent to those skilled in the art from consideration of the specification and practice of the invention disclosed herein.

We claim:

1. A method of accounting for one or more individuals, the method comprising:
determining if an event has occurred or is going to occur;
determining if an entity is affected by the event;
if an event has occurred or is about to occur, implementing an accountability program configured to account for one or more missing individuals, the accountability program further configured to:
pose a number of questions to one or more individuals who have accessed the program,
record information associated with the posed questions, and
generate a log of the information; and
merging the log of information with a source of data to obtain an accountability report.

2. The method of claim 1, further comprising associating one or more continuity representatives with the entity.

3. The method of claim 2, further comprising directing the one or more individuals to contact an associated continuity representative.

4. The method of claim 1, further comprising using the accountability report to determine one or more missing individuals.

5. The method of claim 1, further comprising designating a time for disseminating the accountability report to a designated individual.

6. The method of claim 2, further comprising directing one or more continuity representatives to provide a list of missing individuals.

7. The method of claim 1, wherein the accountability program is further configured to account for one or more missing individuals until a deadline.

8. The method of claim 7, further comprising taking additional steps to account for missing individuals after the deadline.

9. A computer-readable medium containing computer-executable instructions which when executed by a system perform a method of accounting for one or more individuals, the method comprising:
determining if an entity is affected by an event;
if the entity is affected by the event, providing a program configured to account for one or more missing individuals, the program further configured to:
pose a number of questions to one or more individuals who have accessed the program,
record information associated with the posed questions, and
generate a log of the information; and
merging the log of information with other associated data to obtain an accountability report.

10. The computer-readable medium of claim 9, the method further comprising associating one or more continuity representatives with the entity.

11. The computer-readable medium of claim 9, the method further comprising using the accountability report to determine one or more missing individuals.

12. The computer-readable medium of claim 9, the method further comprising designating a time for disseminating the accountability report.

13. The computer-readable medium of claim 9, the method further comprising designating a time for terminating the program.

14. The computer-readable medium of claim 9, the method further comprising providing an interface for accessing the accountability report.

15. The computer-readable medium of claim 9, the method further comprising taking additional steps to account for missing individuals after a deadline.

16. A system configured to account for one or more individuals during a crisis, the system comprising:
means for posing a number of questions to one or more individuals who have accessed the program,
means for recording information associated with the posed questions,
means for generating a log of the information,
means for merging the log of information with other associated data to obtain an accountability report, and
a store for storing the accountability report.

17. The system of claim 16 further configured to determine one or more missing individuals based on the accountability report.

18. The system of claim 16 further comprising an interface for accessing the accountability report from the store.

19. The system of claim 18, wherein the interface comprises a web interface.

20. The system of claim 16 further comprising a hierarchal management structure for accounting for individuals during a crisis.
